(19) United States
(12) Patent Application Publication
(10) Pub. No.: US 2011/0113215 A1
(43) Pub. Date: May 12, 2011

(54) METHOD AND APPARATUS FOR DYNAMIC RESIZING OF CACHE PARTITIONS BASED ON THE EXECUTION PHASE OF TASKS

(75) Inventors: Bijo Thomas, Kottayam (IN); Sriram Krishnan, Kerala (IN); Milind Manohar Kulkarni, Sunnyvale, CA (US); Sainath Karlapalem, Bangalore (IN)

(73) Assignee: NXP B.V., Eindhoven (NL)

(21) Appl. No.: 12/281,359

(22) PCT Filed: Feb. 24, 2007
(86) PCT No.: PCT/IB07/50593

§ 371 Date: Sep. 2, 2008

Related U.S. Application Data
(60) Provisional application No. 60/779,271, filed on Mar. 2, 2006.

(30) Foreign Application Priority Data
Feb. 24, 2007 (IB) PCT/IB2007/050593

(51) Int. Cl. G06F 12/06

(52) U.S. Cl. 711/173; 711/E12.084

(57) ABSTRACT

The present invention proposes a method and a system for dynamic cache partitioning for application tasks in a multiprocessor. An approach for dynamically resizing cache partitions based on the execution phase of the application tasks is provided. The execution phases of the application tasks are identified and updated in a tabular form. Cache partitions are resized during a particular instance of the execution of application tasks such that the necessary and sufficient amount of cache space is allocated to the application tasks at any given point of time. The cache partition size is determined according to the working set requirement of the tasks during its execution, which is monitored dynamically or statically. Cache partitions are resized according to the execution phase of the task dynamically such that unnecessary reservation of the entire cache is avoided and hence an effective utilization of the cache is achieved.

The present invention relates, in general to a data processing system comprising cache storage, and more specifically relates to dynamic partitioning of the cache storage for application tasks in a multiprocessor.

Cache partitioning is a well-known technique in multi-tasking systems for achieving more predictable cache performance by reducing resource interference. In a data processing system comprising of multiprocessors, the cache storage is shared between multiple processes or tasks. The cache storage is partitioned into different sections for different application tasks. It can be advantageous to partition the cache into sections, where each section is allocated to a respective class of processes, rather than the processes sharing entire cache storage. When cache storage is divided into a number of sections, the question arises of how to determine the size of cache partition for different application tasks and when to resize the cache partitions.

US Patent application 2002/0002657A1 by Henk Muller et al discloses a method of operating a cache memory in a system, in which a processor is capable of executing a plurality of processes. Such techniques partition the cache into many small partitions instead of using one monolithic data-cache in which accesses to different data objects may interfere. In such cases, typically the compiler is aware of the cache architecture and allocates the cache partitions to the tasks. Such techniques reserve the partitioned section of the cache for the tasks during its entire duration of execution. Hence, static partitioning techniques often result in either suboptimal usage of cache or insufficient reservations of cache partitions.

Dynamic partitioning techniques as proposed by Edward Suh et al in “Analytical Cache Models with applications to cache partitioning” attempt to avoid the above said drawback of static partitioning by dynamically resizing the partition sizes. Such techniques do not consider the program characteristics like phased execution of the individual tasks. For instance, the execution behavior of multimedia applications often falls into repeating behaviors (phases), which may have different cache usage characteristics. Effective cache usage can be achieved by determining the partition sizes at the program phase boundaries.

Timothy et al have described that it is possible to accurately identify and predict the phases in program behavior [Ref. 2: “Discovering and exploiting program phases”, Timothy Sherwood et al]. The program (task) behavior in these phases has different resource usage characteristics and can be quantified using performance metrics. An example of such a metric is basic block vector [BBV] described in [Ref. 2].

Current cache partitioning techniques reserve the partitioned section of the cache storage for the application tasks for their entire duration of execution. But media processing tasks have distinct phases of execution and the cache requirements vary in each of these phases. In multi-tasking real-time systems, application task switches due to arrival of high priority application tasks. Switching of application tasks due to interrupts is also common These task switches could occur at different execution phases of the currently executing task. Current cache partitioning techniques do not address this varying demand for cache.

Hence, there exists an unsatisfied need for dynamic resizing of cache partition assigned for each task in a multiprocessor according to the execution phase so that only minimal amount of cache space is allocated at any given time. The solution for this problem will ensure that sufficient (or more optimal) cache space is available for the incoming task (interrupting task or high priority task that is switched in).

The present invention proposes a method and a system for dynamic cache partitioning for each application task in a multiprocessor. An approach for dynamically resizing cache partitions based on the execution phase of the application tasks is provided. Cache partitions are dynamically resized according to the execution phase of the current task such that, unnecessary reservation of the entire cache is avoided and hence an effective utilization of the cache is achieved.

In a multiprocessor, multitasking scenarios with shared cache/memory, partitioning is often conceived as a mechanism to achieve the predictable performance of the memory subsystem. Several partitioning schemes are available in the literature such as Way Partitioning (Column Caching), Set Partitioning, etc. Streaming applications adopt a pattern of execution that has distinct phases with distinct durations. The objective of the present invention is to exploit the information regarding the distinct phases of execution of the multimedia application tasks and hence adapt the partition size based on the requirements during their executions phases. Execution phases of the application task (program) can be identified in many ways: one example is by monitoring the working set changes and other methods [Ref. 2]. The execution phases of application tasks are defined as the set of intervals within the application task's execution that have similar behaviour, and the working set of the application task is defined as the cache partition requirements of the application task at a particular execution phase.

One aspect of the present invention provides a method for dynamically resizing cache partitions based on the execution phase of the application tasks. The execution phases of the application tasks are identified and updated in a tabular form. Cache partitions are resized during a particular instance of the execution of tasks such that the necessary and sufficient amount of cache space is allocated to the tasks at any given point of time. The cache partition size is determined according to the working set requirement of the tasks during its execution, which is monitored dynamically or statically.

Another aspect of the present invention provides a computer system for dynamically resizing cache partitions for the application tasks in a multiprocessor. The system comprises a task phase monitor for monitoring the working set variations of application tasks which can be either monitored dynamically or the information can be collected statically and stored in the same. The phase information of the tasks is stored in a task phase table. The task phase table contains the phase and the cache partition allocated (which is the working set of the application task at the corresponding phase) at the time of switching of the tasks.

The system also comprises of a cache allocation controller for allocating maximum cache size when a new application task interrupts a currently executing task. When a new application task interrupts the currently executing task, the cache allocation controller looks at the working set requirements of the new application task and partitions the cache by allocating maximum possible cache size to the new task. The cache storage allocation is done according to the phase of the new application task.

One object of the present invention is to devise a method and means for dynamically managing cache partitioning among a plurality of processes executing on a computing system.

Another object of the present invention is to improve the cache utilization by avoiding unnecessary reservation of the cache partitions for the executing application tasks during the entire duration of their execution.

Another object of the present invention is to increase the probability of having a greater portion of the working set of the interrupting task to be mapped onto the cache. So when a higher priority task or an interrupt occurs, there will be more cache available to be allocated for the interrupting task.

The above summary of the present invention is not intended to describe each disclosed embodiment of the present invention. The figures and detailed description that follow provide additional aspects of the present invention.

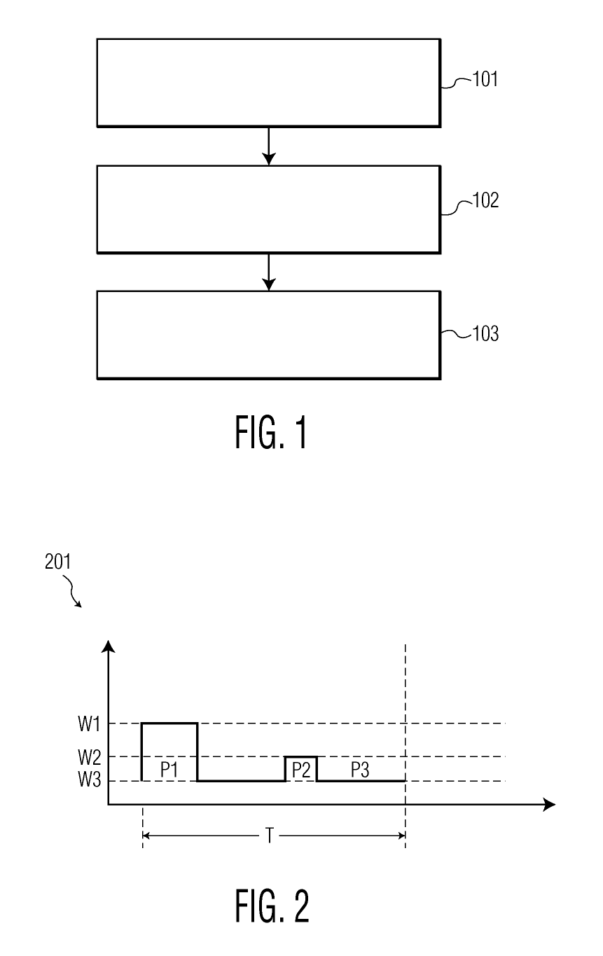

FIG. 1 illustrates an embodiment of the method of dynamically resizing cache partitions in a multiprocessor for the application tasks.

FIG. 2 is a graphical depiction showing the working set variations for an application task.

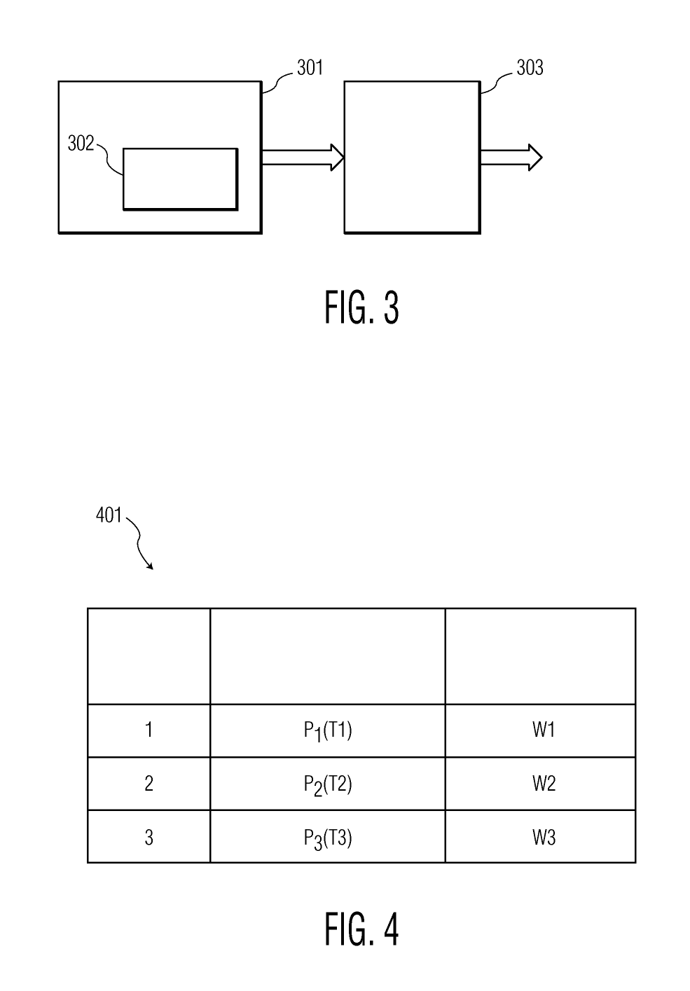

FIG. 3 presents a block diagram illustrating the architecture of an embodiment of a system for dynamically resizing cache partitions for the application tasks.

FIG. 4 illustrates a task phase table for storing information of application tasks.

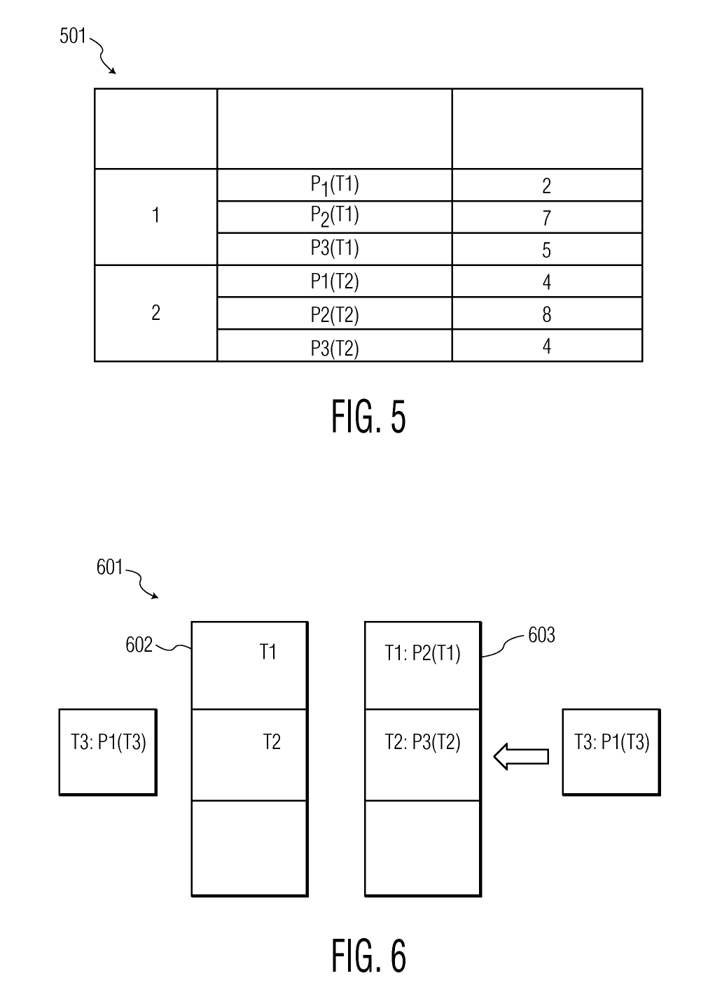

FIG. 5 illustrates a snapshot depicting an example of cache requirements for two application tasks (T1 and T2).

FIG. 6 illustrates the cache partitioning scenario for the example shown in FIG. 5 when a new application task, T3, interrupts the currently executing application tasks (T1 and T2).

The foregoing and other features, aspects and advantages of the present invention are described in detail below in connection with the accompanying drawings. The drawings comprise of 6 figures.

FIG. 1 illustrates an embodiment of the method of dynamically resizing cache partitions in a multiprocessor for the application tasks. Using basic block vector (BBV) metrics or working set of the application task, the execution phases of each of the application task is identified 101. The phase information and working set of an application task is stored in tabular form 102. This phase information is then utilized for dynamically configuring the cache partition depending on the execution phase of the application task 103.

According to the proposed invention, the cache partitions are resized during a particular instance of the execution of application tasks such that the necessary and sufficient amount of cache space is allocated to the application tasks at any time. The cache partition size is determined according to the working set requirement of the tasks during its execution. The working set requirements of the tasks can be monitored dynamically or statically. By avoiding redundant reservation of the cache partitions for the application tasks for the entire duration of their execution, the overall cache utilization is improved.

FIG. 2 illustrates a graph depicting the working set variations for an application task 201. Variation of the working set W (t) for an application task during the period of execution ‘T’ of the task is shown in FIG. 2. The working set of the application task varies during its execution period T. Accordingly there are distinct phases P1, P2 and P3 corresponding to the working sets W1, W2 and W3. Depending on the system conditions like schedule quantum, interrupts, data/space availability of the input/output buffers, etc, the application task can get switched at any of the phases of its execution. If the cache partition allocated to the application tasks is constant (as in prior art) during its period of execution T, this would result in a redundant blocking of the cache partitions.

For example, if the cache partition allocated to the application task is equal to that of W1 (bytes), and if the application task switches at P3 (corresponding to W3), then the cache space W1-W3 is unnecessarily blocked for the application task.

FIG. 3 presents a block diagram illustrating the architecture of an embodiment of a system for dynamically resizing cache partitions for the application tasks. The working set variations of the application tasks is monitored by a task phase monitor 301. The working set variations can be either monitored dynamically or the information can be collected statically. This phase information is stored in a task phase table 302. The task phase table 302 contains the phase and the cache partition allocated (which is the working set of the task at the corresponding phase) at the time of switching of the application tasks.

When a new application task interrupts a currently executing application task, the cache allocation controller 303 looks at the working set requirements of the new application task and partitions the cache by allocating maximum possible cache size to the new application task, in observance with the phase of the new application task.

FIG. 4 illustrates a task phase table 302 for storing the phase information of application tasks 401. The task phase table 302 includes a separate task ID for each of the application tasks, the phase information of the application task and cache partition size allocated for each application task at the time of switching of tasks. The phase information of the application task is denoted as P₁ (T1), P₂ (T2) and P₃ (T3) respectively for three successive application tasks, T1, T2 and T3 and P1, P2, P3 are three distinct phases of the three tasks. Also, the cache partition size allocated for each application task at the time of switching of tasks is denoted as W1, W2 and W3.

FIG. 5 illustrates a snapshot depicting an example of cache requirements for two application tasks 501. Consider the snapshot of cache requirements of two application tasks T1 and T2 as shown in FIG. 5. Assume that the total cache size is 20 lines. The application tasks are running in a multi-tasking mode, switching from one task to the other. After a period of time assume that the execution has resulted in the cache having task T1 in phase P2 (T1) and task T2 in phase P3 (T2). The total cache that has been taken up is 7+4=11 lines, leaving 9 lines free.

FIG. 6 illustrates the cache partitioning scenario for two cases of examples 601 when a new application task interrupts a currently executing application task. In FIG. 5, consider the situation when a new application task T3 (interrupting task) arrives at phase P1 (T3) with a working set requirement of 8 lines. In the conventional mode of cache partition which is shown in Casel 602, the cache size would have been allocated based on maximum cache requirements, i.e., 7 for task T1 and 8 for task T2, over the entire duration of execution. This would have consumed 15 lines until task T1 and task T2 finish their execution.

In Case 2 603, task T3 could be allocated leaving 1 line free. If the tasks T1, T2 were in some other phases of their execution, the allocation in Case 1, 601 and Case 2, 602 would be more dramatic. For instance if task T1 and T2 were in phase P1 (T1) and P1 (T2) respectively, when task T3 arrived, there would have been 20−(2+4)=14 lines available for T3. Thus with the case 2 even if the working set for task T3 was more (maximum 14), there will be free lines available for the interrupting application task.

The present invention will find its industrial applications in system on chip (SoC) for audio, video and mobile applications. The present invention will improve the cache utilization by avoiding unnecessary reservation of the cache partitions for the executing application tasks during the entire duration of their execution. So an effective utilization of the cache storage is achieved.

What is claimed is:

1. A method of dynamically resizing cache partitions in a multiprocessor for a plurality of application tasks wherein, said multiprocessor being capable of executing said plurality of application tasks, comprising of a main memory and a cache memory wherein, said cache memory comprises a set of cache partitions, the method comprising the steps of:
identifying and monitoring execution phases of the plurality of application tasks;
maintaining and updating information regarding said execution phases and working set of a current application task; and
configuring said cache partitions dynamically depending on the execution phases of said current application task whereby, avoiding redundant reservation of the cache partitions for the execution tasks for the entire duration of their execution.

2. The method of claim 1 wherein, the application tasks comprises a sequence of instructions.

3. The method of claim 1 wherein, the execution phases of the application tasks comprises a set of intervals within the application task's execution that have similar behaviour.

4. The method of claim 1 wherein, said working set of the application tasks comprises the cache partition requirements of the application tasks at a particular execution phase.

5. The method of claim 1 wherein, monitoring execution phases of said execution tasks is implemented statically and cache partition size is determined according to the working set requirements of the application tasks during execution.

6. The method of claim 1 wherein, monitoring execution phases of said execution tasks is implemented dynamically and cache partition size is determined according to the working set requirements of the application tasks during execution.

7. The method of claim 1 wherein, when a higher priority task occurs, adequate cache partition is available to be allocated to said higher priority task whereby, sufficient portion of the working set of the higher priority task is mapped onto the cache.

8. The method of claim 1 wherein, cache partitions assigned for each application task is varied according to the execution phase whereby, only the optimal amount of cache space is allocated at any given time.

9. A system for dynamically resizing cache partitions in a multiprocessor for a plurality of application tasks wherein, said multiprocessor being capable of executing said plurality of application tasks, comprising of a main memory and a cache memory wherein, said cache memory comprises a set of cache partitions, comprising of:
a task phase monitor for monitoring working set variations of application tasks;
a storage for storing phase information regarding application tasks from said task phase monitor; and
a cache allocation controller for allocating maximum cache size when a new application task interrupts a currently executing application task.

10. The system as in claim 9 wherein, said storage comprises a task phase table further comprising of the phase information of application tasks and cache partition size allocated for each application task at the time of switching of tasks wherein, cache partition size allocated for each application task comprises the working set of the task at the corresponding phase.

11. The system as in claim 9 wherein, said task phase monitor monitors said working set variations statically and stored in task phase table.

12. The system as in claim 9 wherein, the task phase monitor monitors working set variations dynamically and stored in the storage.

13. The method of claim 9 wherein, the application tasks comprises a sequence of instructions.
